(19) United States
(12) Patent Application Publication
(10) Pub. No.: US 2016/0367059 A1
(43) Pub. Date: Dec. 22, 2016

(54) Scintillating Lighted Ornament

(71) Applicant: John William Embler, Oakland Park, FL (US)

(72) Inventor: John William Embler, Oakland Park, FL (US)

(21) Appl. No.: 15/014,814

(22) Filed: Feb. 3, 2016

Related U.S. Application Data
(60) Provisional application No. 62/087,748, filed on Dec. 4, 2014.

(51) Int. Cl. A47G 33/08; F21V 7/00; F21V 13/02; A47G 33/10; F21V 21/088; F21V 21/15; F21S 10/06; F21V 11/14; F21V 14/02; F21V 21/08

(52) U.S. Cl. CPC A47G 33/0809; F21V 14/02; F21V 7/0025; F21V 13/02; F21V 21/0816; F21V 21/088; F21V 21/15; F21S 10/063; F21V 11/14; A47G 33/10; F21W 2121/00

(57) ABSTRACT

A tree ornament for being positioned on top of a tree to decorate the tree includes a base being configured to be mounted on a top of the tree. A centerpiece includes a reflective surface to reflect light off of the centerpiece. The centerpiece is mounted to the base. An enclosure with apertures is coupled to the base. The enclosure with apertures extends upwardly from the base and surrounds the centerpiece. Each of a plurality of light assemblies is coupled to the enclosure and arranged around the centerpiece. Each of the light assemblies is electrically coupled to a power supply. The light assemblies emit light towards the centerpiece to be reflected off of the centerpiece when the light assemblies are provided power by the power supply. Light reflected off the centerpiece is filtered and selectively directed by the apertures in the enclosure.

### BACKGROUND OF THE INVENTION

1. Field of the Invention

The present invention relates to mirror balls and more particularly pertains to a new mirror ball for being positioned on top of a tree to decorate the tree.

2. Description of the Prior Art

The use of mirror balls is known in the prior art. While these devices fulfill their respective, particular objectives and requirements, the need remains for a system that has certain improved features that allows light directed onto a centerpiece of the system to be reflected into an area adjacent a tree that the system is positioned on. Additionally, the system should include an opaque or translucent enclosure to conceal the centerpiece and transparent or translucent apertures in said enclosure to selectively direct light reflected from the centerpiece onto adjacent objects and areas to produce a unique scintillating effect.

### SUMMARY OF THE INVENTION

The present invention meets the needs presented above by generally comprising a base being configured to be mounted on a top of the tree. A centerpiece includes a reflective surface to reflect light off of the centerpiece. An enclosure with apertures surrounding the centerpiece. The centerpiece is mounted to the base. The enclosure is coupled to the base. The enclosure extends upwardly from the base and surrounds the centerpiece. Each of a plurality of light assemblies is coupled to the enclosure and arranged around the centerpiece. Each of the light assemblies is electrically coupled to a power supply. The light assemblies emit light towards the centerpiece to be reflected off of the centerpiece when the light assemblies are provided power by the power supply. Light reflected off the centerpiece is filtered and selectively directed by the apertures in the enclosure.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The objects of the invention, along with the various features of novelty which characterize the invention, are pointed out with particularity in the claims annexed to and forming a part of this disclosure

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front cross-sectional view of the present invention.

FIG. 2 is a perspective cross-sectional view of the present invention.

FIG. 3 is a perspective view of the present invention.

FIG. 4 is a front view of the present invention shown in use.

### DESCRIPTION OF THE PREFERRED EMBODIMENT

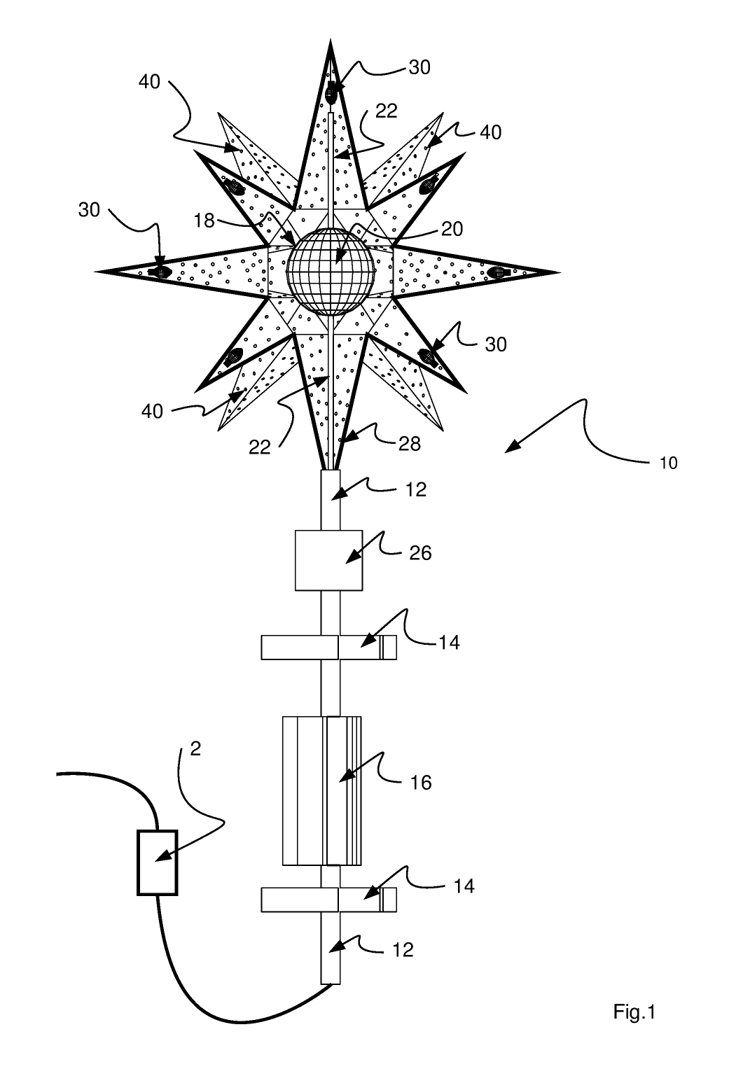

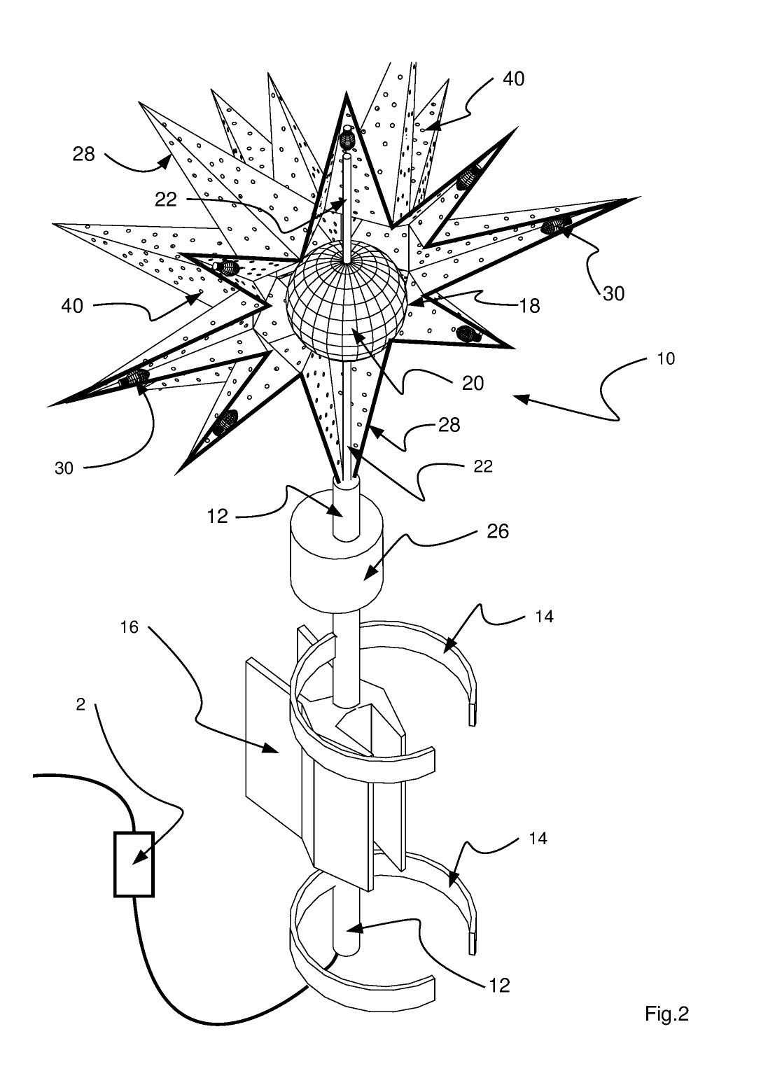

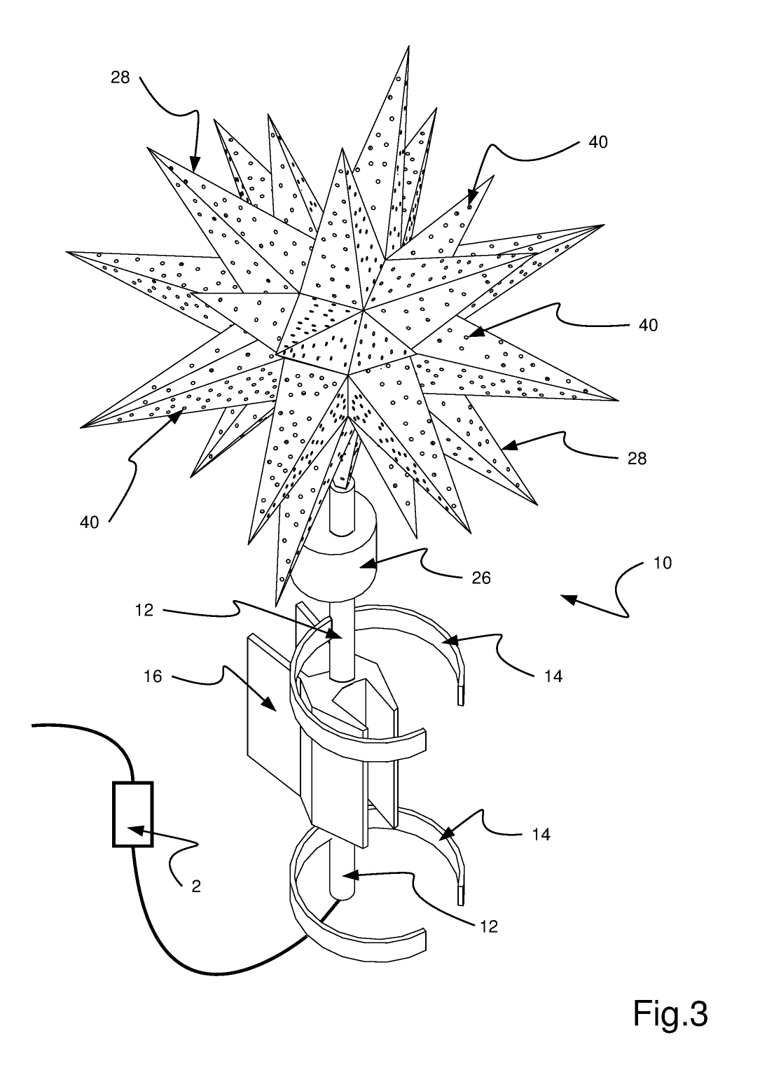

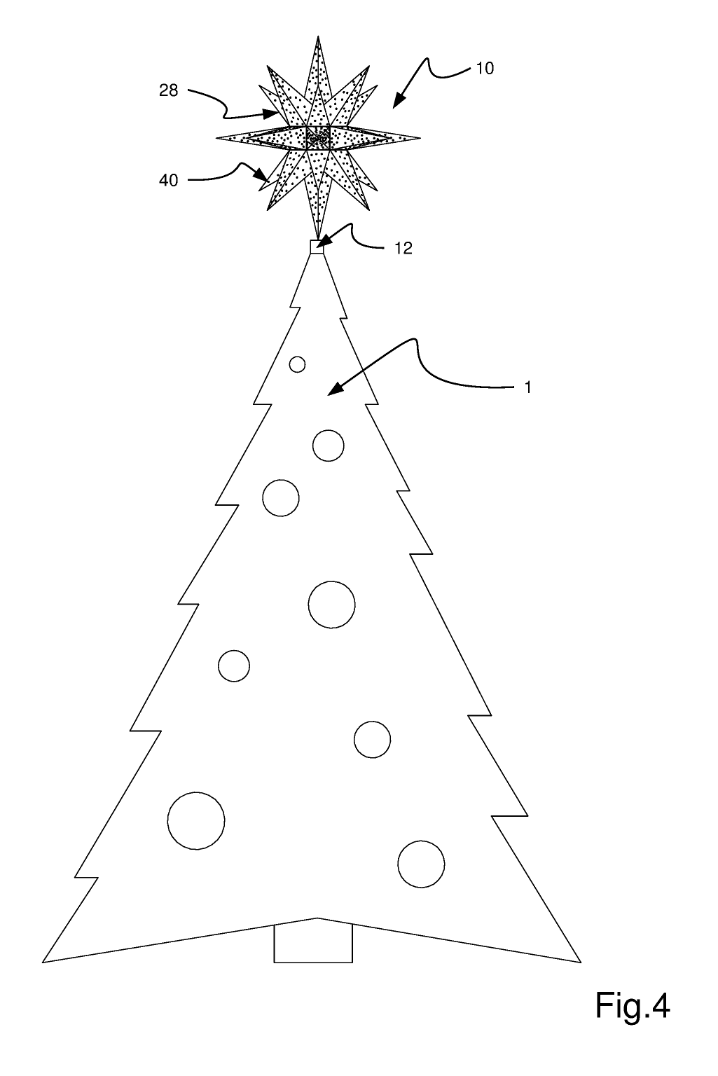

With reference now to the drawings, and in particular to FIGS. 1 through 4 thereof, a new mirror ball embodying the principles and concepts of the present invention and generally designated by the reference numeral 10 will be described.

As best illustrated in FIGS. 1 through 4, the tree ornament 10 generally comprises a base 12 being configured to be mounted on top of a tree 1. The base 12 may include straps 14 or clamps 16 to attach the base 12 to the tree 1.

A centerpiece 18 includes a reflective surface 20 to reflect light off of the centerpiece 18. The centerpiece 18 may be ball shaped and includes a plurality of adjoined planar surfaces. An axle 22 is rotatably coupled to the base 12. The upper end of the axle 22 is attached to the centerpiece 18.

A motor 26 is coupled to the base 12. The motor 26 is electrically coupled to a power supply 2. The motor 26 is mechanically coupled to the axle 22 to rotate the axle 22 and the centerpiece 18 with respect to the base 12 when the motor 26 is supplied with power from the power supply 2. The motor 26 may be positioned within the base 12.

An enclosure 28 is coupled to the base 12. The enclosure 28 extends upwardly from the base 12 and is positioned around the centerpiece 18. Each of a plurality of light assemblies 30 is coupled to the enclosure 28 and arranged around the centerpiece 18.

Each of the light assemblies 30 is electrically coupled to the power supply 2. The light assemblies 30 emit light towards the centerpiece 18 to be reflected off of the centerpiece 18 when the light assemblies 30 are provided power by the power supply 2. Apertures 40 in the enclosure 28 selectively filter and direct light emitted from the light assemblies 30 reflecting off the centerpiece 18.

In use, the base 12 is attached to the top of the tree 1 to position the base 12 on top of the tree 1. The motor 26 is then electrically coupled to the power supply 2. The motor 26 rotates the centerpiece 18 above the base 12. The light assemblies 30 emit light onto the centerpiece 18 to illuminate the centerpiece 18 and the reflective surface 20 of the centerpiece 18 reflects light from the light assemblies 30 through the apertures 40 into an area adjacent to the tree 1.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A lighted ornament, said ornament comprising:
a base;
a centerpiece including a reflective surface to reflect light off of said centerpiece, said centerpiece being mounted to said base;
an enclosure with apertures being coupled to said base, said enclosure with apertures extending from said base and surrounding said centerpiece such that said apertures selectively filter light reflected off said centerpiece; and
a plurality of light assemblies being coupled to said enclosure and arranged around said centerpiece, each of said light assemblies being electrically coupled to a power supply, said light assemblies emitting light towards said centerpiece to be reflected off of said centerpiece when said light assemblies are provided power by the power supply.

2. The ornament according to claim 1, wherein said base includes straps.

3. The ornament according to claim 1, wherein said base includes clamps.

4. The ornament according to claim 1, wherein said centerpiece is ball shaped and including a plurality of adjoined planar surfaces.

5. The ornament according to claim 1, further comprising an axle being rotatably coupled to said base, said axle having an upper end attached to said centerpiece.

6. The ornament according to claim 5, further comprising a motor being coupled to said base, said motor being electrically coupled to the power supply, said motor being mechanically coupled to said axle to rotate said axle and said centerpiece with respect to said base when said motor is supplied with power from the power supply.

7. The ornament according to claim 6, wherein said motor is positioned within said base.

8. The ornament according to claim 1, further comprising a motor being coupled to said base, said motor being electrically coupled to the power supply, said motor being mechanically coupled to said enclosure to rotate said enclosure with respect to said base when said motor is supplied with power from the power supply.

9. The ornament according to claim 1, wherein said base is configured to hang from a substantially horizontal surface.

10. The ornament according to claim 1, wherein each said base is configured to attach to a substantially vertical surface.

11. The ornament according to claim 1, wherein said enclosure is substantially opaque.

12. The ornament according to claim 1, wherein said enclosure is substantially translucent.

13. The ornament according to claim 1, wherein said apertures are substantially transparent.

14. The ornament according to claim 1, wherein said apertures are substantially translucent.

15. The ornament according to claim 1, wherein the interior surfaces of said enclosure are substantially reflective.

16. The ornament according to claim 1, wherein said enclosure may be shaped to resemble a decorative object, including but not limited to a star, planet, Santa, angel, animal, heart or pumpkin.

17. The ornament according to claim 1, wherein said apertures may be shaped to resemble a decorative object, including but not limited to a star, planet, Santa, angel, animal, heart or pumpkin.
